(19) United States
(12) Patent Application Publication
(10) Pub. No.: US 2020/0194919 A1
(43) Pub. Date: Jun. 18, 2020

(54) ELECTRIC TERMINAL HOUSING WITH A TERMINAL LOCK

(71) Applicant: Lear Corporation, Southfield, MI (US)

(72) Inventors: Deborah Probert, Farmington Hills, MI (US); Michael Glick, Winston-Salem, NC (US); David Menzies, Linden, MI (US); Tulasi Sadras-Ravindra, Canton, MI (US)

(73) Assignee: Lear Corporation, Southfield, MI (US)

(21) Appl. No.: 16/220,186

(22) Filed: Dec. 14, 2018

(51) Int. Cl. H01R 13/436; H01R 13/422; H01R 13/502; H01R 13/64; H01R 13/18; H01R 43/20

(52) U.S. Cl. CPC H01R 13/436; H01R 13/422; H01R 43/20; H01R 13/64; H01R 13/18; H01R 13/502

(57) ABSTRACT

A terminal housing includes a terminal cavity that extends along a cavity axis from a first end to a second end. The terminal cavity is adapted to hold an electric terminal. The terminal housing also includes an orientation groove that extends parallel to the cavity axis from the first end. The orientation groove is open to the terminal cavity along its length. The terminal housing also includes a terminal lock. The terminal lock includes a resilient arm that extends from a wall of the orientation groove.

### BACKGROUND OF THE INVENTION

This invention relates to a housing for an electric terminal. More specifically, this invention relates to a housing for an electric terminal including a terminal lock located in an orientation groove of the terminal housing.

Electric terminals are used in a variety of applications where it is desirable to create an electric connection between various components of a circuit. Electric terminals are typically installed in a housing for ease of use. The housing holds each electric terminal in a desired position and orientation and allows a user to easily connect each electric terminal to its respective mate. Typical housings include plugs, headers, wall jacks, and wall plates.

The housing includes a body that defines one or more cavities for the electric terminals. The housing and the electric terminal may include cooperating orientation features. These orientation features are used during insertion of the electric terminal into the cavity in order to ensure that the correct electric terminal is placed in the correct cavity and that the electric terminal is positioned correctly within the cavity.

A terminal lock holds the electric terminal in the housing and ensures that the electric terminal does not fall out of the cavity during normal use of the connector. The typical terminal lock includes a resilient arm that engages the body of the electric terminal when the electric terminal is installed in the housing. The electric terminal engages the arm if a force is applied to pull it out of the housing, and this engagement resists such movement of the electric terminal. It would be advantageous to have an alternative terminal lock that retains the terminal in the housing.

### SUMMARY OF THE INVENTION

This invention relates to an electric terminal housing. The terminal housing includes a terminal cavity. The terminal cavity extends along a cavity axis from a first end to a second end. The terminal cavity is adapted to support an electric terminal therein. The terminal housing also includes an orientation groove. The orientation groove extends parallel to the cavity axis from the first end. The orientation groove is open to the terminal cavity along its length. The terminal housing also includes a terminal lock. The terminal lock includes a resilient arm that extends from a wall of the orientation groove.

This invention also relates to an electric terminal assembly. The terminal assembly includes a terminal housing. The terminal housing has a terminal cavity that extends along a cavity axis from a first end to a second end. The terminal housing has an orientation groove that extends parallel to the cavity axis from the first end. The orientation groove is open to the terminal cavity along its length. The terminal housing includes a terminal lock. The terminal assembly also includes an electric terminal. The electric terminal includes a terminal tab that is located in the orientation groove. The terminal lock engages the terminal tab.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is an exploded, perspective view of an electric terminal assembly including an electric terminal and a terminal housing.

FIG. 2 is a side view of the electric terminal illustrated in FIG. 1.

FIG. 3 is an end view of the electric terminal illustrated in FIG. 1.

FIG. 4 is a cross-sectional view taken along the line 4-4 of FIG. 1, through the terminal housing.

FIG. 5 is a cross-sectional view taken along the line 5-5 of FIG. 4.

FIG. 6 is a cross-sectional view taken along the line 6-6 of FIG. 4.

FIG. 7 is a cross-sectional view similar to FIG. 4, showing the electric terminal located in an installed position in the terminal housing.

FIG. 8 is an enlarged perspective view, partially cut-away, of a portion of the terminal housing.

### DETAILED DESCRIPTION OF THE PREFERRED EMBODIMENT

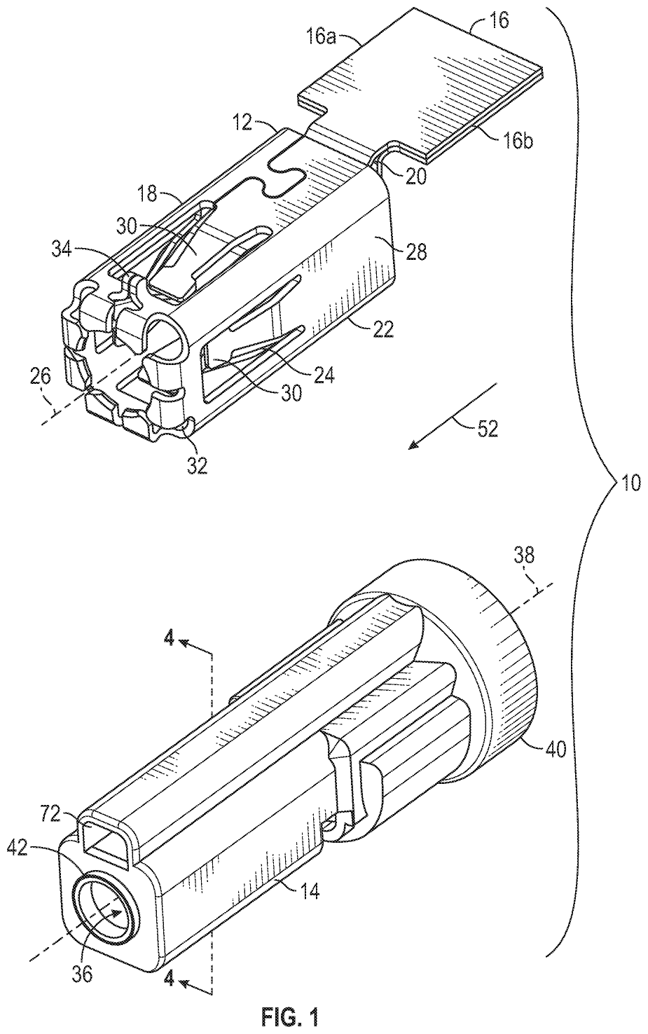

Referring now to the drawings, there is illustrated in FIG. 1 a perspective view of an electric terminal assembly, indicated generally at 10. The electric terminal assembly 10 includes an electric terminal 12 and a terminal housing 14. The terminal housing 14 is adapted to retain the electric terminal 12 in an installed position therein, as will be described below. The electric terminal 12 is adapted to be mated with a corresponding terminal (not shown) to create an electric connection.

The illustrated electric terminal 12 is a female, box-type terminal. However, any desired type of electric terminal 12 may be used with the terminal housing 14. The electric terminal 12 includes an attachment portion 16 that is adapted to be connected to a wire (not shown). The illustrated attachment portion 16 is a weld tab that is adapted to be welded to a conductor of a wire. However, the attachment portion 16 may be attached to any desired electric conductor or component using any desired method or connector. The electric terminal 12 also includes a contact portion 18 that is adapted to be mated with the corresponding terminal. The illustrated electric terminal 12 is a two-piece terminal and includes a contact base 20 and a spring 22.

The illustrated contact base 20 is made of copper but may be made of any desired material. The contact base 20 is stamped from sheet metal and folded into the illustrated shape, but the contact base 20 may be made by any desired method. The attachment portion 16 is part of the contact base 20. The contact base 20 includes a plurality of contact arms 24 attached to attachment portion 16 and form part of the contact portion 18 of the electric terminal 12. The contact arms 24 are located around a terminal axis 26 and are adapted to mate with the corresponding terminal. In the illustrated embodiment, the corresponding terminal is a male electric terminal that is inserted along the terminal axis 26 to mate with the electric terminal 12, as is known in the art.

The illustrated spring 22 is made of stainless steel, but may be made of any desired material. The spring 22 is stamped from sheet metal and folded into the illustrated shape, but the spring 22 may be made by any desired method. The spring 22 includes a spring box 28 that surrounds a portion of the contact base 20. The spring 22 includes a plurality of spring arms 30 that extend from the spring box 28. The spring arms 30 are located around the terminal axis 26 and engage the contact arms 24 to bias the contact arms 24 toward the terminal axis 26. The spring 22 also includes a shroud 32 that is attached to the spring box 28. The shroud 32 is located around the contact arms 24 and serves to protect the contact arms 24 from damage during installation and use of the electric terminal 12.

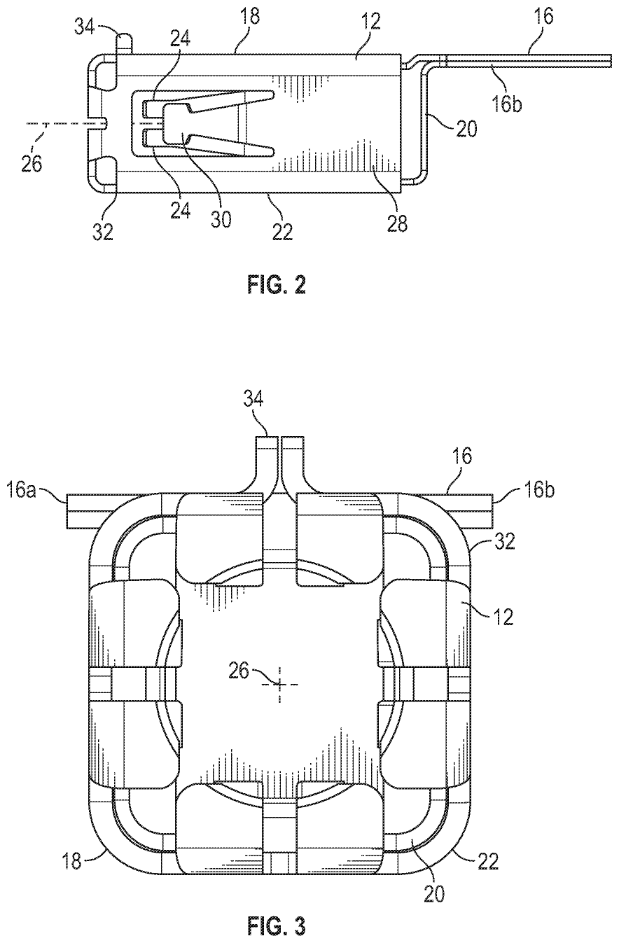

Referring to FIG. 2, a side view of the electric terminal 12 is illustrated and in FIG. 3 an end view of the electric terminal 12 is illustrated. The contact portion 18 of the illustrated electric terminal 12 has a generally square outer cross-sectional shape when viewed perpendicular to the terminal axis 26, as shown in FIG. 3. In the illustrated electric terminal 12, the outer cross-sectional shape is defined by the spring 22. However, the outer cross-sectional shape of the electric terminal 12 may be defined by any desired part of the electric terminal 12 and may have any desired shape.

The electric terminal 12 includes a terminal tab 34 that extends away from the terminal axis 26 beyond the outer cross-sectional shape. The terminal tab 34 serves as an orientation feature that limits the manner in which the electric terminal 12 can be inserted into the terminal housing 14, as will be described below. The illustrated terminal tab 34 is located on the shroud 32 of the spring 22. However, the terminal tab 34 may be located on any desired part of the electric terminal 12. As shown in FIG. 3, the illustrated terminal tab 34 is located at the center of one side of the spring 22 and extends perpendicularly to the terminal axis 26. However, the terminal tab 34 may be located in any desired location and have any desired orientation. The illustrated terminal tab 34 is made from the material of the spring 22 that is folded into the illustrated shape. However, the terminal tab 34 may be made from any desired material and may be made by any desired method.

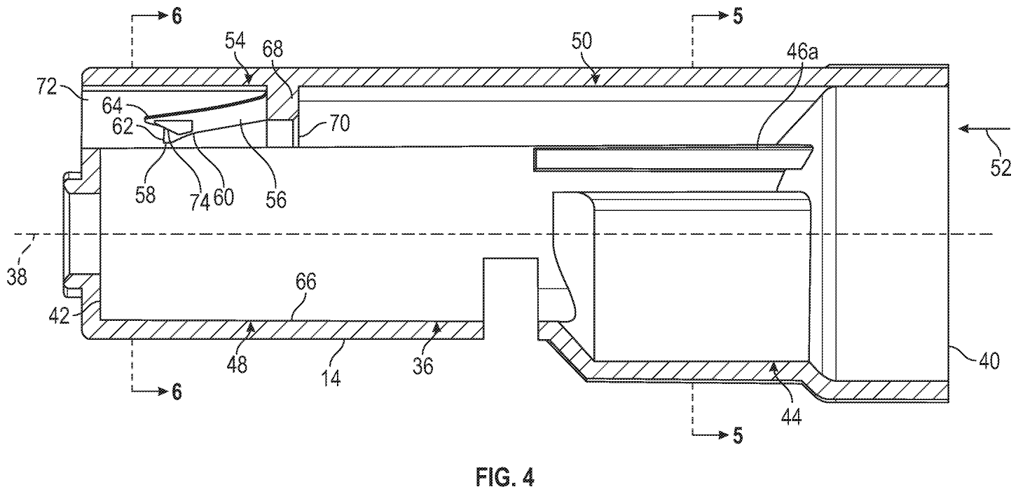

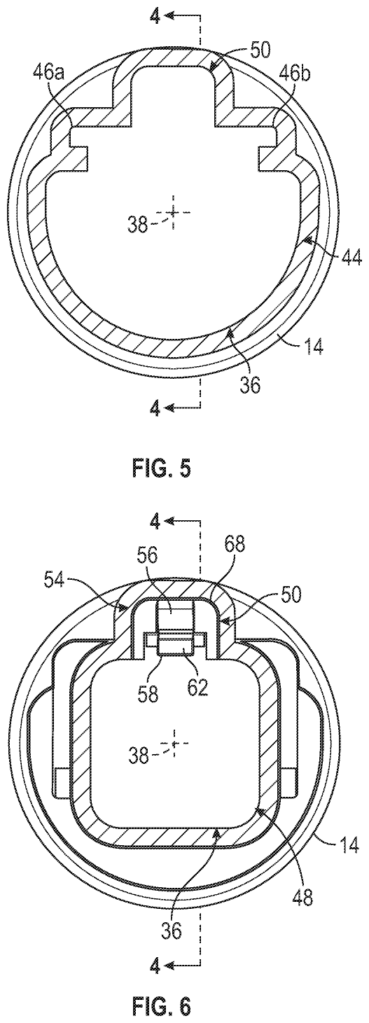

The illustrated terminal housing 14 is molded from plastic, but may be made of any desired material and by any desired method. The terminal housing 14 is provided for illustrative purposes, and the terminal housing 14 may be any desired type of retainer for the electric terminal 12, including a header or an electric connector. The terminal housing 14 defines a terminal cavity, indicated generally at 36. The terminal cavity 36 extends along a cavity axis 38 from an insertion end 40 to a mate end 42. Referring to FIG. 4, there is illustrated a cross-sectional view of the terminal housing 14 taken along the line 4-4 of FIG. 1. FIG. 5 and FIG. 6 are cross-sectional views taken along the lines 5-5 and 6-6 of FIG. 4, respectively.

The terminal cavity 36 includes an attachment cavity, indicated generally at 44, located at the insertion end 40. The attachment cavity 44 is adapted to accommodate the attachment portion 16 of the electric terminal 12 and the attached wire. The terminal housing 14 includes a first slot 46a and a second slot 46b that are located on opposed sides of the attachment cavity 44. The first slot 46a and the second slot 46b both open toward the insertion end 40 and both also open into the attachment cavity 44. The first slot 46a and the second slot 46b open facing each other and are adapted to hold the attachment portion 16, as will be described below. The terminal cavity 36 also includes a contact cavity, indicated generally at 48, located between the attachment cavity 44 and the mate end 42. The contact cavity 48 is adapted to accommodate the contact portion 18 of the electric terminal 12. The contact cavity 48 has a generally square inner cross-sectional shape when view perpendicularly to the terminal axis 26. However, the contact cavity 48 may have any desired shape.

The terminal housing 14 includes an orientation groove, indicated generally at 50, located on one side of the terminal cavity 36. The illustrated orientation groove 50 extends from the insertion end 40 to the mate end 42, but may have any desired length. The orientation groove 50 is open to the terminal cavity 36 along its full length. The orientation groove 50 is adapted to accommodate the terminal tab 34 when the electric terminal 12 is inserted into the terminal housing 14.

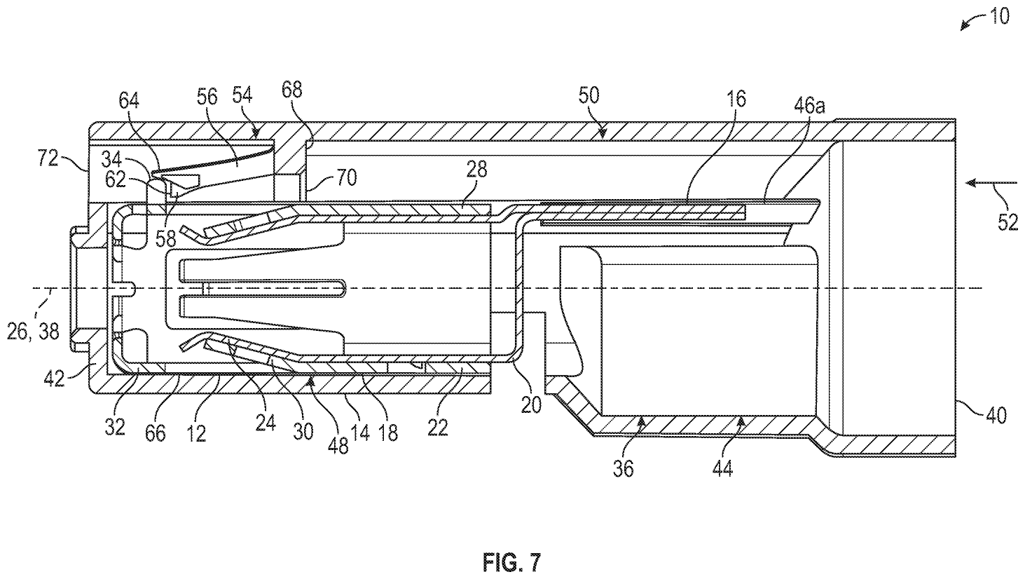

In order to place the electric terminal 12 in the installed position in the terminal housing 14, the terminal axis 26 is initially aligned with the cavity axis 38 with the contact portion 18 adjacent to the insertion end 40. The electric terminal 12 is then moved relative to the terminal housing 14 in an insertion direction 52 so that the contact portion 18 passes through the attachment cavity 44 and into the contact cavity 48. If the electric terminal 12 is in an improper orientation relative to the terminal housing 14, either the shroud 32 or the terminal tab 34 will engage a wall of the terminal cavity 36 to prevent further movement of the electric terminal 12 in the insertion direction 52. When the electric terminal 12 is properly oriented relative to the terminal housing 14, the terminal tab 34 is aligned with the orientation groove 50 and the electric terminal 12 can be moved in the insertion direction 52 relative to the terminal housing 14 until the electric terminal 12 is located in the installed position, illustrated in FIG. 7.

When the electric terminal 12 is in the installed position, the attachment portion 16 of the electric terminal 12 is located in the attachment cavity 44. In the illustrated embodiment, the orientation groove 50 and the cavity axis 38 are located on opposed sides of the attachment portion 16. However, the attachment portion 16 may be located in any desired position when the electric terminal 12 is in the installed position. As previously described, the illustrated attachment portion 16 is adapted to be welded to the conductor of a wire. The wire may be any desired size in order to conduct a desired amount of current. The attachment portion 16 may be any desired size in order to be attached to the desired wire. The illustrated attachment cavity 44 is larger than the contact cavity 48 in order to accommodate a relatively large wire and a weld nugget (not shown) formed when the wire is welded to the attachment portion 16. However, the attachment cavity 44 may have any desired size.

When the electric terminal 12 is in the installed position, the weight of the wire can exert a force on the electric terminal 12 to move it from the installed position. The terminal housing 14 includes features to retain the electric terminal 12 in the installed position. Referring back to FIG. 1, the attachment portion 16 includes a first edge 16a and a second edge 16b that are located on opposed sides of the attachment portion 16. When the electric terminal 12 is in the installed position, illustrated in FIG. 7, the first edge 16a is located in the first slot 46a and the second edge 16b is located in the second slot 46b. The attachment portion 16 engages the terminal housing 14 in order to restrict movement of the attachment portion 16 relative to the terminal housing 14. The first slot 46a and second slot 46b prevent the attachment portion 16 from moving toward or away from the cavity axis 38 or in any direction other than parallel to the insertion direction 52. The first slot 46a and the second slot 46b also prevent the attachment portion 16 from rotating relative to the cavity axis 38. As previously described, the wire attached to the electric terminal 12 may be any desired size. If a relatively light wire is used, or if the wire is otherwise restrained from moving the electric terminal 12, then the attachment portion 16 may be small enough that the first edge 16a and second edge 16b are not located in the first slot 46a and second slot 46b, if desired.

The terminal housing 14 includes a terminal lock, indicated generally at 54, that retains the electric terminal 12 in the installed position in the terminal housing 14. The terminal lock 54 is illustrated in an initial position in FIG. 4. The terminal lock 54 includes a resilient arm 56 that extends from the terminal housing 14 into the orientation groove 50. The arm 56 extends toward the cavity axis 38 and toward the mate end 42 of the terminal cavity 36. A catch 58 extends from the arm 56 toward the cavity axis 38. The terminal lock 54 includes a deflection surface 60 located on the catch 58 toward the insertion end 40. The terminal lock 54 includes a lock surface 62 located on the catch 58 toward the mate end 42. The terminal lock 54 also includes a protrusion 64 that extends from the arm 56 toward the mate end 42, and which is located closer to the mate end 42 than the lock surface 62.

When the electric terminal 12 is inserted into the terminal housing 14 and moved in the insertion direction 52 toward the installed position, the terminal tab 34 initially engages the deflection surface 60 and pushes the catch 58 away from the cavity axis 38, causing the arm 56 to bend. When the terminal tab 34 has been moved in the insertion direction 52 past the catch 58, the arm 56 will rebound, causing the catch 58 to move back toward the cavity axis 38. As shown in FIG. 7, the protrusion 64 on the terminal lock 54 engages the terminal tab 34 to limit the amount of rebounding movement of the catch 58 toward the cavity axis 38. The terminal lock 54 is then in a locked position. When the terminal lock 54 is in the locked position, the catch 58 is located farther away from the cavity axis 38 than when the terminal lock 54 is in the initial position. Thus, the arm 56 remains stressed and applies a force to the electric terminal 12, thus pressing the electric terminal 12 against an opposed wall 66 of the terminal cavity 36 that is located opposite the orientation groove 50.

When the terminal lock 54 is in the locked position, the lock surface 62 is located opposite the insertion direction 52 of the terminal tab 34. If a force is applied to the electric terminal 12 to pull it out of the terminal cavity 36, the terminal tab 34 will engage the lock surface 62, and the terminal lock 54 will resist movement of the electric terminal 12. Thus, the terminal tab 34 acts as both an orientation feature, to ensure that the electric terminal 12 is properly oriented in the terminal cavity 36, and also as a lock feature, to ensure that the electric terminal 12 remains in the installed position in the terminal cavity 36.

The terminal lock 54 is located in the orientation groove 50 and only engages the terminal tab 34 when the electric terminal 12 is moved into the installed position. The illustrated terminal lock 54 does not engage any other part of the spring 22 or any part of the contact base 20. However, the terminal lock 54 may engage any desired part of the electric terminal 12. As best shown in FIG. 3, the illustrated terminal tab 34 includes two layers of material. When the terminal tab 34 is pulled against the lock surface 62, these two layers will engage the terminal lock 54. However, the terminal tab 34 may have any desired shape or dimension, and the terminal tab 34 may have additional layers of material in order to increase the contact area between the terminal tab 34 and the terminal lock 54.

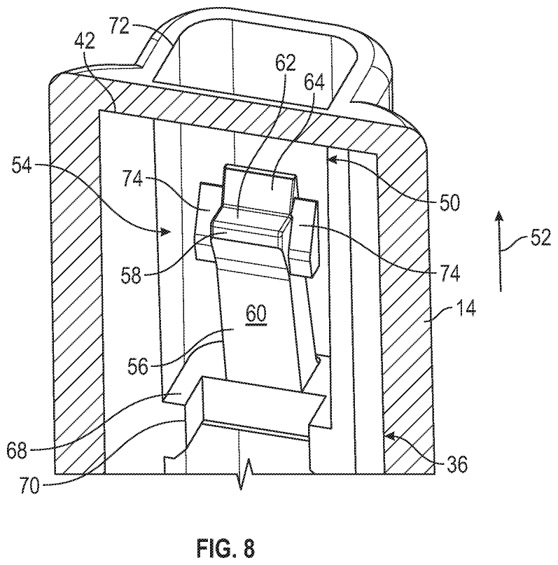

Referring to FIG. 8, a perspective view of the terminal housing 14 is shown, cut-away so that the terminal lock 54 is visible. The terminal housing 14 includes a lock saddle 68 that is located in the orientation groove 50. The lock saddle 68 is a raised ridge of material that extends into the orientation groove 50. The lock saddle 68 defines a tab pass 70 in the orientation groove 50 that extends parallel to the cavity axis 38. The tab pass 70 allows the terminal tab 34 to move past the lock saddle 68. The arm 56 extends from the lock saddle 68.

The illustrated terminal housing 14 is serviceable, and the electric terminal 12 may be removed from the installed position, if desired. The terminal housing 14 includes a release opening 72 that allows a release tool (not shown) to be inserted in order to move the terminal lock 54 from the locked position to a release position. The illustrated release opening 72 is located at an end of the orientation groove 50that is adjacent to the mate end 42 of the terminal cavity 36. The terminal lock 54 includes one or more release surfaces 74 located on opposite sides of the arm 56. As best shown in FIG. 4, the release surfaces 74 are sloped relative to the cavity axis 38 so that the release tool may be inserted through the release opening 72, engage the release surfaces 74, and push the catch 58 away from the cavity axis 38.

The principle and mode of operation of this invention have been explained and illustrated in its preferred embodiment. However, it must be understood that this invention may be practiced otherwise than as specifically explained and illustrated without departing from its spirit or scope.

1-18. (canceled)

19. An electric terminal assembly comprising:
a terminal housing including:
(1) an insertion end,
(2) a mate end,
(3) a terminal cavity that extends from the insertion end to the mate end,
(4) an orientation groove in the terminal cavity that defines an inner surface of the terminal housing, and
(5) a terminal lock extending from the inner surface of the terminal housing into the orientation groove; and
an electric terminal disposed within the terminal cavity and including
(1) a contact portion disposed adjacent to the insertion end,
(2) an attachment portion disposed adjacent to the mate end, and
(3) a terminal tab that extends within the orientation groove and cooperates with the terminal lock to prevent removal of the electrical terminal from the terminal cavity.

20. The electrical terminal defined in claim 19 wherein the orientation groove extends from the insertion end of the terminal housing toward the mate end of the terminal housing.

21. The electrical terminal defined in claim 19 wherein the orientation groove extends from the insertion end of the terminal housing to the mate end of the terminal housing.

22. The electrical terminal defined in claim 19 wherein the terminal lock includes a resilient arm that is movable from a locked position, wherein removal of the electrical terminal from the terminal cavity is prevented, to a released position, wherein removal of the electrical terminal from the terminal cavity is permitted.

23. The electrical terminal defined in claim 22 wherein the terminal housing includes a release opening that allows a release tool to be inserted therethrough to move the terminal lock from the locked position to the released position.

24. The electrical terminal defined in claim 19 wherein the terminal housing includes a lock saddle that extends from the inner surface of the terminal housing into the orientation groove, and the terminal lock extends from the lock saddle.

25. The electrical terminal defined in claim 19 wherein the electrical terminal includes a spring that is supported on attachment portion, and the terminal tab is provided on the spring.

26. The electrical terminal defined in claim 25 wherein the contact portion of the electrical terminal includes a plurality of contact arms that extend from the attachment portion, the spring includes a shroud that extends about the plurality of contact arms, and the terminal tab is provided on the shroud.

27. A terminal housing for an electric terminal assembly comprising:
a terminal housing including:
(1) an insertion end,
(2) a mate end,
(3) a terminal cavity that extends from the insertion end to the mate end,
(4) an orientation groove in the terminal cavity that defines an inner surface of the terminal housing, and
(5) a terminal lock extending from the inner surface of the terminal housing into the orientation groove.

28. The terminal housing for an electrical terminal defined in claim 20 wherein the orientation groove extends from the insertion end of the terminal housing toward the mate end of the terminal housing.

29. The terminal housing for an electrical terminal defined in claim 20 wherein the orientation groove extends from the insertion end of the terminal housing to the mate end of the terminal housing.

30. The terminal housing for an electrical terminal defined in claim 20 wherein the terminal lock includes a resilient arm that is movable from a locked position, wherein removal of the electrical terminal from the terminal cavity is prevented, to a released position, wherein removal of the electrical terminal from the terminal cavity is permitted.

31. The terminal housing for an electrical terminal defined in claim 30 wherein the terminal housing includes a release opening that allows a release tool to be inserted therethrough to move the terminal lock from the locked position to the released position.

32. The terminal housing for an electrical terminal defined in claim 20 wherein the terminal housing includes a lock saddle that extends from the inner surface of the terminal housing into the orientation groove, and the terminal lock extends from the lock saddle.
